(19) United States
(12) Patent Application Publication
(10) Pub. No.: US 2013/0166719 A1
(43) Pub. Date: Jun. 27, 2013

(54) INFORMATION PROCESSING APPARATUS, INFORMATION PROCESSING METHOD, AND COMPUTER-READABLE STORAGE MEDIUM

(71) Applicant: Kazunori SUGIMURA, Kanagawa (JP)

(72) Inventor: Kazunori SUGIMURA, Kanagawa (JP)

(21) Appl. No.: 13/727,183

(22) Filed: Dec. 26, 2012

(30) Foreign Application Priority Data
Dec. 26, 2011 (JP) 2011-283390
Nov. 21, 2012 (JP) 2012-255407

(51) Int. Cl. H04L 12/24

(52) U.S. Cl. CPC H04L 41/06
USPC 709/223

(57) ABSTRACT

An information processing apparatus remotely managed by a management apparatus includes an event reception unit configured to receive an event that occurs inside; a plurality of event processing units configured to generate a message to be transmitted to the management apparatus, the event processing units corresponding to events, respectively; and a processing distribution unit configured to determine distribution of the event received by the event reception unit to the corresponding event processing unit. The event processing units are generated by the processing distribution unit.

### CROSS-REFERENCE TO RELATED APPLICATION

The present application claims priority to and incorporates by reference the entire contents of Japanese Patent Application No. 2011-283390 filed in Japan on Dec. 26, 2011 and Japanese Patent Application No. 2012-255407 filed in Japan on Nov. 21, 2012.

### BACKGROUND OF THE INVENTION

1. Field of the Invention

The present invention relates to an information processing apparatus, an information processing method, and a computer-readable storage medium.

2. Description of the Related Art

A remote device management system using a multifunction peripheral (MFP) is well known.

However, so far a solution for a method of remotely managing a device as a system, a more robust management method, and the like has been considered, but memory saving on the device side and expandability at the time of development have not been taken into consideration in the solution. Because of this, there is a problem in terms of evolving the same mechanism for a variety of devices in future.

Therefore, a variety of proposals have been proposed (for example, refer to Japanese Patent Application Laid-open No. 2004-234639, Japanese Patent Application Laid-open No. 2004-265388, and Japanese Patent Application Laid-open No. 2006-279181). The invention disclosed in Japanese Patent Application Laid-open No. 2004-234639 relates to “a communication apparatus, a system for remotely managing the communication apparatus, a control method at the time of occurrence of a cause for transmission, and a program”. The detailed disclosure is as follows: “An image formation apparatus transmits toner supply call information (the prior event information), which makes a tone near end (an order for a toner bottle) reported, to a management apparatus, when detecting the toner near end by an occurrence of the toner near end (a prior abnormal event). At that time, the image formation apparatus sets a flag of a supply call in progress, indicating that transmission of the toner supply call information is in progress, to 1. Thereafter, the image formation apparatus determines that the transmission of the toner supply call information is successful and resets the flag of a supply call in progress to 0, when receiving a transmission result to the effect that the reception of the toner supply call information is normally completed, from the management apparatus.”.

The invention disclosed in Japanese Patent Application Laid-open No. 2004-265388 relates to “a communication apparatus, a system for remotely managing the communication apparatus, a control method at the time of occurrence of an abnormality, and a program”. The detailed disclosure is as follows: “The management-needed apparatus (the communication apparatus) sets a flag in a SC call in the NV-RAM (nonvolatile storage medium) to 1, and transmits the call information that makes SC reported, to the management apparatus, when detecting SC (the abnormality), but again transmits the SC call information when it is recognizable that the flag in the SC call in the NV-RAM is set to 1, when a primary power source turns on/off during the transmission processing (when the supplying of electric power to all apparatuses is once stopped and then resumed).”.

The invention disclosed in Japanese Patent Application Laid-open No. 2006-279181 relates to “an emergency information reception apparatus and an emergency information reception method”. The detailed disclosure is as follows: “A public circuit in which a circuit connection is performed by transmitting a dial signal is used as a communication circuit; information relating to a sender registered in advance with the apparatus itself is searched for by receiving outgoing telephone number information supplied from the communication circuit and using the outgoing telephone number information as a search key; in addition, a notification class corresponding to an incoming telephone number registered in advance with the apparatus itself is searched for by receiving incoming telephone number information supplied from the communication line and using the incoming telephone number information as a search key; the notification class of a sender and a type of emergency information terminal at the sender house are determined before receiving a call signal; a notification receiving operation in accordance with the notification class and the type of emergency notification terminal is performed; and the information on the sender is displayed.”.

The inventions described in Japanese Patent Application Laid-open No. 2004-234639 and Japanese Patent Application Laid-open No. 2004-265388 disclose a method in which the retransmission processing is made possible, in a case where an event to be transmitted to the center occurs, such as toner near end and device abnormality that occur inside the device, but the transmitting processing is stopped on the way, for example, due to power-off. In addition, many proposals for the same kind of technology have been made, but most of them relate mainly to communication between a center and a device and to a device management method, and have problems in that in a case where the same mechanism is evolved for a variety of devices, a large amount of memory consumption itself may prevent the application thereof and a new device cannot be accommodated as an extension. Furthermore, the invention described in Japanese Patent Application Laid-open No. 2006-279181 is a technology as an emergency information system, but it is an example of building up a system in which a sending/receiving telephone number is determined as a key, and is not related to the problems described above.

Therefore, there is a need for an information processing apparatus, an information processing method, and a computer-readable storage medium that are capable of enabling embedded functions with memory saving and of accommodating future expandability and evolution.

### SUMMARY OF THE INVENTION

It is an object of the present invention to at least partially solve the problems in the conventional technology.

According to an embodiment, there is provided an information processing apparatus remotely managed by a management apparatus. The information processing apparatus includes an event reception unit configured to receive an event that occurs inside; a plurality of event processing units configured to generate a message to be transmitted to the management apparatus, the event processing units corresponding to events, respectively; and a processing distribution unit configured to determine distribution of the event received by the event reception unit to the corresponding event processing unit. The event processing units are generated by the processing distribution unit.

According to another embodiment, there is provided an information processing method that includes collecting information and state from an inside of an information processing apparatus in response to an event with regard to the information processing apparatus as a trigger; generating a message that is mapped to the event and is to be actually exchanged, from the collected information; and transmitting the message from the information processing apparatus to a management apparatus that remotely manages the information processing apparatus.

According to still another embodiment, there is provided a non-transitory computer-readable storage medium with an executable program stored thereon. The program instructs a computer of an information processing apparatus remotely managed by a management apparatus, to perform: generating an event by an user's operation through a user operation control unit; generating an event by a state-in-device monitoring unit; receiving an event that occurs inside by an event reception unit; determining, by a processing distribution unit, distribution of the event to an event processing unit that corresponds to the event; generating, by an event processing unit, a message the event processing unit generates a message to be transmitted to the management apparatus; and transmitting the message to the management apparatus by a communication unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an explanatory diagram for describing a software configuration of a remote management system, as a whole, using an information processing apparatus in accordance with a first embodiment;

FIG. 2 is an explanatory diagram for describing in detail an event reception unit 104 and an event processing unit 105, illustrated in FIG. 1;

FIG. 3 is an explanatory diagram for describing a sequence at the time of error occurrence in the configuration described in FIG. 2;

FIG. 4 is an explanatory diagram for describing state changes of the event reception unit;

FIG. 5 is an explanatory diagram for describing specific state changes;

FIG. 6 is one example of a sequence diagram of an initialization process for writing the state described in FIG. 5, at the time of starting;

FIG. 7 is an explanatory diagram for describing a sequence at the time of performing an installation process;

FIG. 8 is an explanatory diagram for describing a software configuration of a remote management system, as a whole, using an information processing apparatus in accordance with a second embodiment; and

FIG. 9 is a diagram for describing a sequence at the time of error occurrence in the second embodiment.

### DETAILED DESCRIPTION OF THE PREFERRED EMBODIMENTS

Here, there is a likelihood that devices, such as a projector and a conference system, may be objects that a management system has to manage, and the present invention has taken into consideration the efficiency of developing the devices that will be manufactured from now on. Furthermore, the present invention has been contrived with importance placed on expandability, because what has not been so far necessary to be notified has to be notified, or the expandability has to be taken into consideration, in a case where the number of management-needed objects is increased. A prompt response may be made even if a new device falls into categories of the management-needed objects in the future and what has to be notified takes place.

### First Embodiment

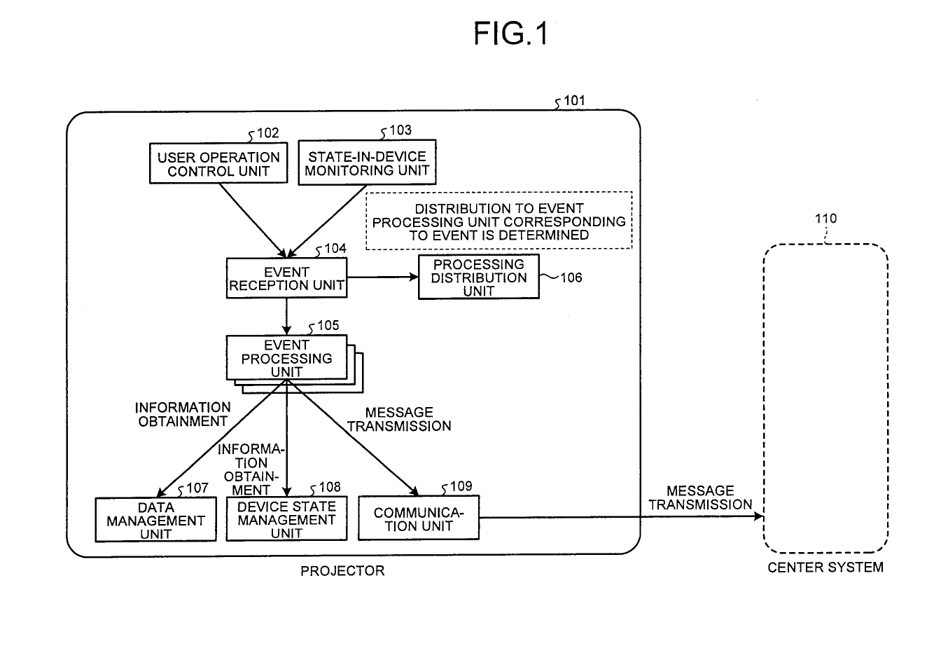

FIG. 1 is an explanatory diagram for describing a software configuration of a remote management system, as a whole, using an information processing apparatus in accordance with a first embodiment.

The system, illustrated in FIG. 1, includes a projector (an information processing apparatus 101) as the information processing apparatus, and a center system 110, as a management apparatus, which remotely manages the information processing apparatus 101.

The information processing apparatus 101 is configured to include a user operation control unit 102, a state-in-device monitoring unit 103, an event reception unit 104, an event processing unit 105, a processing distribution unit 106, a data management unit 107, and a device state management unit 108, and a communication unit 109.

The center system 110 is configured to include, for example, a server.

A configuration of a remote device management system is one in which a message is transmitted from the information processing apparatus 101 (the projector), which is a management-needed device, toward the center system 110 (or is reversely received by the information processing apparatus 101 from the center system 110). With this configuration, the center system 110 manages and realizes information on a large number of devices.

In accordance with the present embodiment, the point is an internal design configuration of the information processing apparatus 101 on the left side of FIG. 1.

In the remote management system, the processing, which transmits the message from the information processing apparatus 101, which is the management-needed device, toward the center system 110, operates by determining an event, which occurs mainly in the user operation control unit 102 or the state-in-device monitoring unit 103, as a trigger. For example, a “registration processing” or a “communication test call execution” is enumerated as a main event that occurs in the user operation control unit 102. Similarly, for example, an “error occurrence notification” is enumerated as a main event that occurs in the state-in-device monitoring unit 103.

The event which occurs in the user operation control unit 102 or the state-in-device monitoring unit 103 reaches the event reception unit 104. Thereafter, the processing is handed over to the event processing unit 105 in order to actually write the message to be notified to the center system 110. Necessary device information and device state are basically collected inside the device, the collected data is built up in the form of a message, and the corresponding message is transmitted to the center system 110. Because of this, the event processing unit 105 is designed in such a manner as to use components, capable of obtaining the device information and the device state, such as the data management unit 107 and the device state management unit 108. The event processing unit 105 uses the communication unit 109 in order to actually notify the message over a network. This is a flow of the basic processing in a case where the message is transmitted from the information processing apparatus 101, which is the management-needed device, to the center system 110.

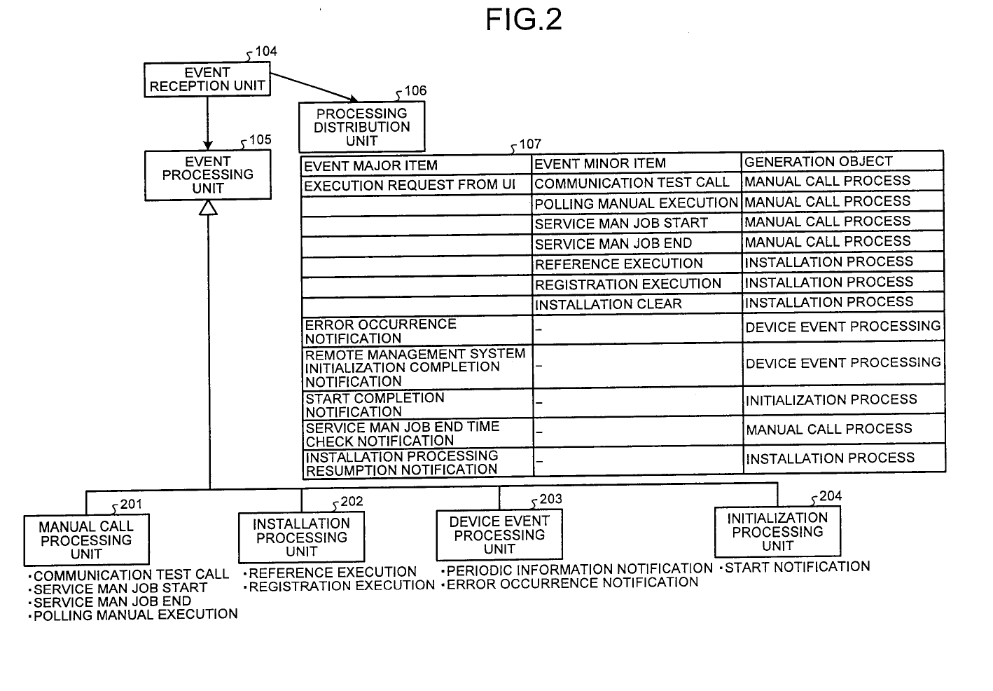

FIG. 2 is an explanatory diagram for describing in detail the event reception unit 104 and the event processing unit 105, illustrated in FIG. 1.

As described in FIG. 1, in the processing in which the message is transmitted from the information processing apparatus 101, which is the management-needed device, to the center system 110, by being triggered by the event inside the device, the information and the state are collected from the inside of the device such that a message, which is associated with the event and is actually to be exchanged, is created, and actually transmitted.

FIG. 2 describes in detail the processing of, for example, the event.

No matter what event occurs, the flow of the basic processing remains the same, but kinds of messages to be written are different. Because of this, the event processing unit 105 is actually detailed on the basis of processing content (for example, a “manual call processing unit”). A group of these processing units is designed in such a manner that all of them are viewed as the same event processing unit 105 when viewed from the event reception unit 104. Basic parts of the group of processing units are made common as the event processing unit 105 and additionally each processing unit is treated as an extension to the event processing unit 105. Because of this, memory may be saved as much as the basic parts are made common, and even if a new “certain processing unit” will be added from now on, it may be the extension without having any influence on the event reception unit 104 and the existing event processing unit 105.

Furthermore, at the time when the event occurs in the device, distribution to the processing unit that corresponds to the event is performed by the processing distribution unit 106. The event reception unit 104 receives the event and hands the event over to the processing distribution unit 106. The processing distribution unit 106 has a map of correspondence between the event occurring in the device and the event processing unit 105. The processing distribution unit 106 determines the processing unit corresponding to the event that occurs, referring to this map. Accordingly, the event reception unit 104 has a configuration that may perform processing execution without recognizing a detailed kind of the event processing unit 105 (a sequence is illustrated below).

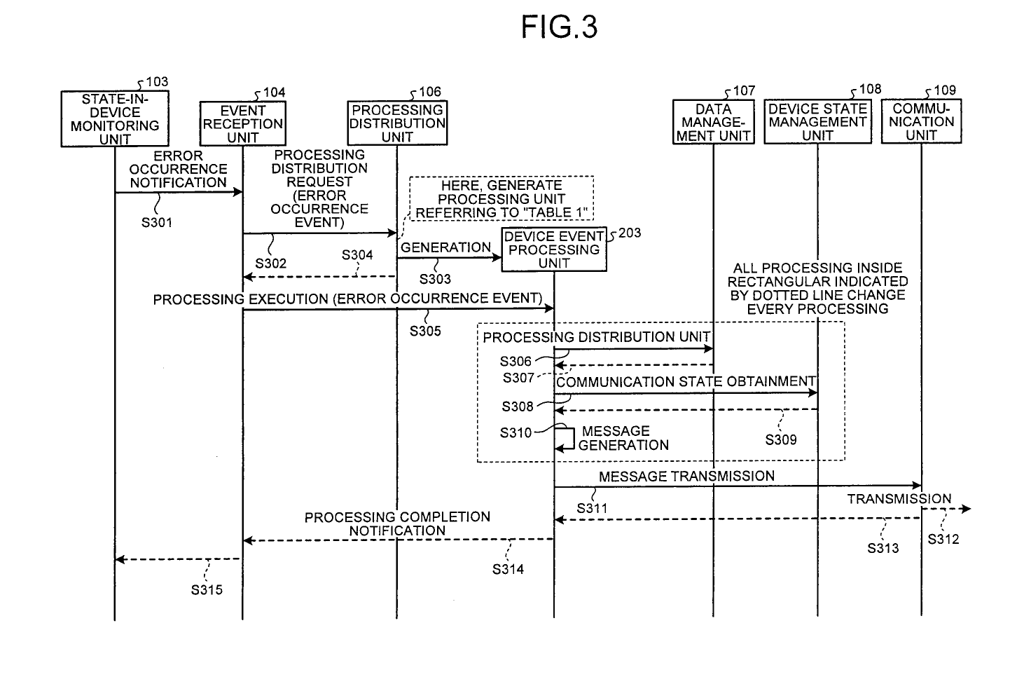

FIG. 3 is an explanatory diagram for describing the sequence at the time of error occurrence in the configuration described in FIG. 2. FIG. 3 illustrates one example of a sequence diagram in a case where an error occurrence notification is issued inside the device.

The event reception unit 104 that receives the error occurrence notification (Step S301) by the state-in-device monitoring unit 103 performs requesting the processing distribution unit 106 to perform the processing distribution. At this time, the event of the error occurrence notification is handed over (Step S302).

The processing distribution unit 106 checks for the map of correspondence between the event and the processing unit, generates a device event processing unit 203 corresponding to the error occurrence notification, and hands the device event processing unit 203 over to the event reception unit 104 (Step S304).

The event reception unit 104 requests the device event processing unit 203, which is returned from the processing distribution unit 106, to perform the processing execution. Also at this time, the event (the error occurrence notification) is handed over (Step S305).

The device event processing unit 203 (the event reception unit 104 is recognized as the device event processing unit 203), on which the processing execution is performed, obtains error notification information necessary for an error notification from the data management unit 107 (Step S306), builds up (generates) the message (Step S310) after obtaining a communication state from the device state management unit 108 (Step S308), and transmits the message outside the device via the communication unit 109 (the message here is an “error occurrence message”.).

When the message is transmitted from the device event processing unit 203 to the communication unit 109 (Step S311), the communication unit 109 transmits the message to the center system 110 (Step S312) and makes a response to the device event processing unit 203 (Step S313). The device event processing unit 203 sends a processing completion notification to the event processing unit 105 (Step S314) and the event reception unit 104 makes a response to the state-in-device monitoring unit 103 (Step S315).

Moreover, error notification information obtainment (Steps S306 and S307), communication state obtainment (Steps S308 and S309) and message generation (Step S310), which are processing inside a rectangular indicated by the dotted line, are changed every processing.

At this point, the basic flow does not change even though an initial event trigger is the event from the user operation control unit 102 (refer to FIG. 1), and “the information obtainment from the data management”, “the state obtainment from the device state management”, and “the generation of the message”, inside the device event processing unit 203 only vary in accordance with their respective processing content.

Because of this, even if the need to add a new processing unit occurs, only the addition of the map of correspondence between the event inside the device and the processing unit in the processing distribution unit 106 and the writing of a new processing unit may minimize influence on the existing part.

Table 1 is one example of a table (correspondence information) for correspondence between the event and the processing unit, which has the configuration specifically described in FIG. 2.

TABLE 1

| Event major item | Event minor item | Generation object |
|---|---|---|
| Execution | Communication | Manual call process |
| request from | test call | |
| user | | |
| | Polling manual | Manual call process |
| | execution | |
| | Service man job | Manual call process |
| | start | |
| | Service man job | Manual call process |
| | end | |
| | Reference | Installation process |
| | execution | |
| | Registration | Installation process |
| | execution | |
| | Installation | Installation process |
| | clear | |
| Error | — | Device event processing |
| occurrence | | |
| notification | | |
| Remote | — | Device event processing |
| management | | |
| system | | |
| initialization | | |
| completion | | |
| notification | | |
| Start | — | Initialization process |
| completion | | |
| notification | | |
| Service man job | — | Manual call process |
| end time check | | |
| notification | | |
| Installation | — | Installation process |
| processing | | |
| resumption | | |
| notification | | |

Table 1 is a table showing a correspondence relationship between the event and the processing unit that the processing distribution unit 106 refers to. Because the events are divided into major items and minor items only on the basis of an execution request of the user, the device event processing unit 203, which becomes a generation object by the content of the minor item, is determined only on the basis of the execution request of the user.

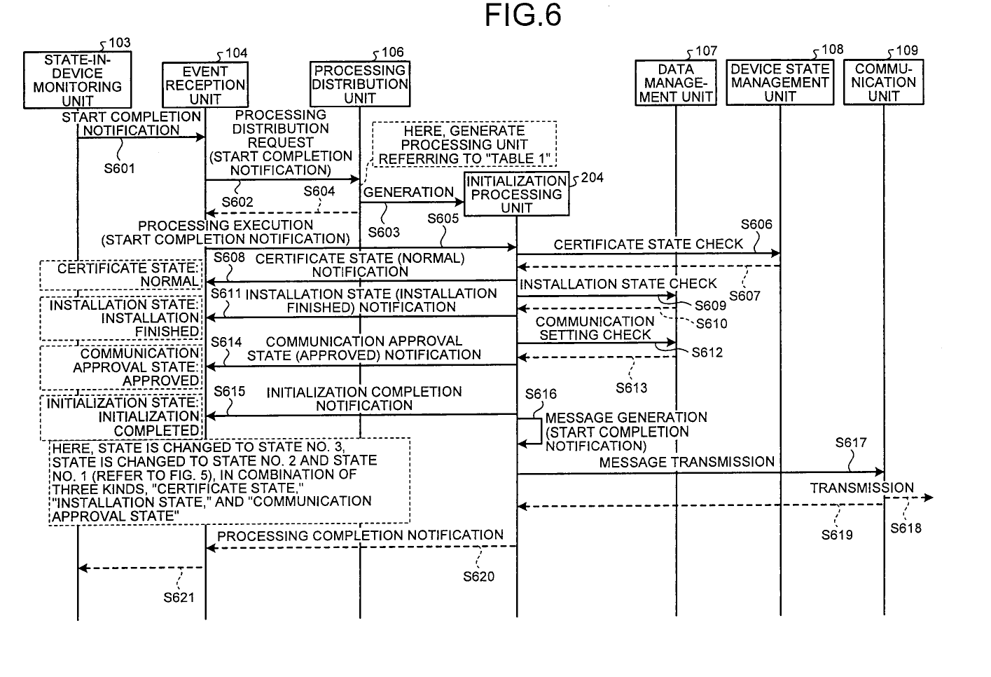

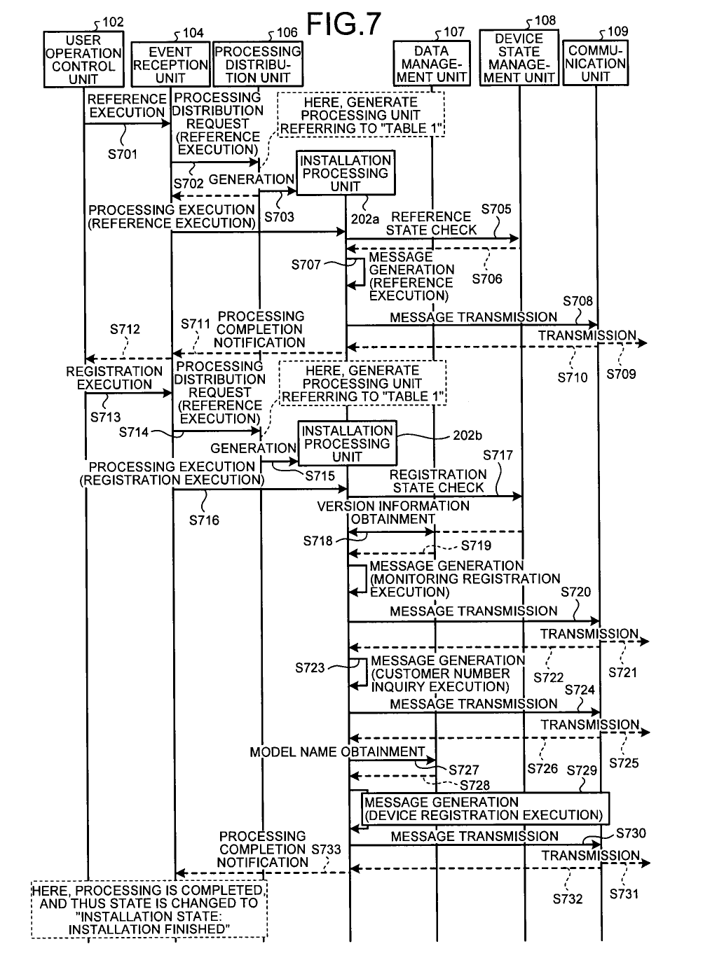

Furthermore, the sequence associated with the error occurrence notification is described in FIG. 3 and the sequence associated with start completion notification in FIG. 6 and the sequence associated with the execution request from the user: reference execution and registration execution in FIG. 7.

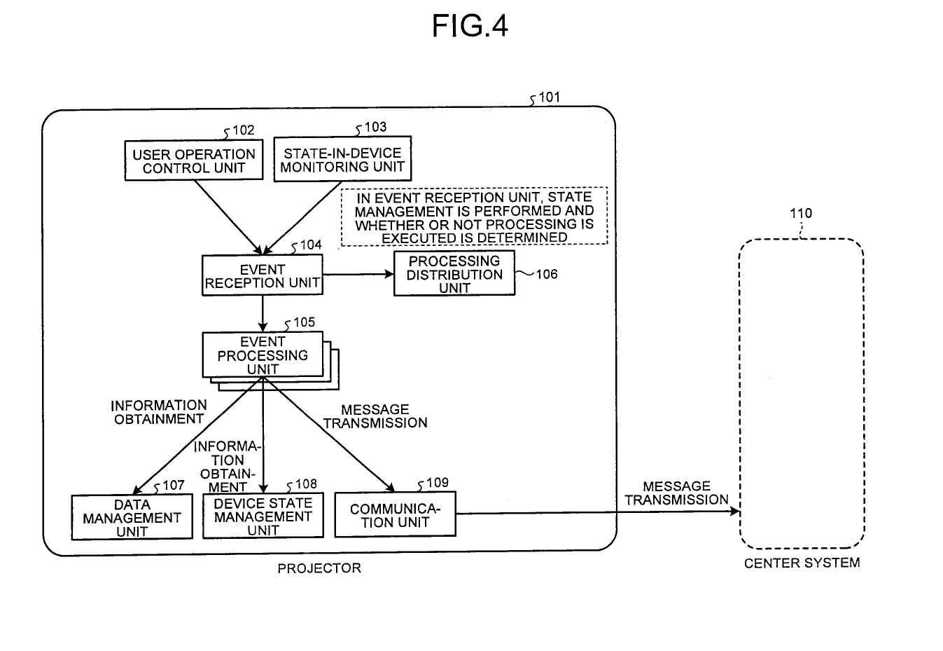

FIG. 4 is an explanatory diagram for describing the state changes of the event reception unit.

In FIG. 4, in order to greatly localize (to greatly promote efficiency of) the processing in the event processing unit 105, the state inside the device is made managed in the event reception unit 104, with the configuration illustrated in FIG. 1, and the process that is not likely to request the event processing unit 105 to perform the processing execution is added in a case where the state of the device is a state in which the remote device management system is not effective (a state in which operation of the event processing unit 105 is unnecessary). When the above is realized, each processing unit, which is an extension to the event processing unit 105, is configured in such a manner that each processing unit has only to consider the writing of its own message, at the time of being mounted (that means only the data information obtainment from the data management and device state management, the writing of the message, and the transmission request to the communication unit).

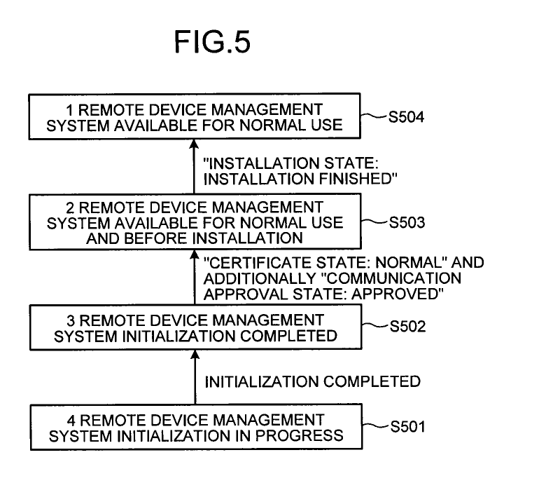

Next, how the state management is performed is described referring to Table 2 and FIG. 5.

Table 2 and FIG. 5 are a table and an explanatory diagram for describing the specific state changes.

TABLE 2

| | | | Communication | | |
|---|---|---|---|---|---|
| | Initialization | Installation | approval | Certificate | AtRemote |
| | state | state | state | state | application state |
| 1: Remote device | Initialization | Installation | Approved | Normal | All functions |
| management system | completed | finished | | | available |
| available for | | | | | |
| normal | | | | | |
| 2: Remote device | Initialization | Not | Approved | Normal | In addition to |
| management system | completed | Installation | | | No. 3 functions, |
| available for | | | | | reference and |
| normal and before | | | | | registration is |
| installation | | | | | executable |
| 3: Remote device | Initialization | Installation | Approved | Abnormal | Only function |
| management system | completed | finished | Not Approved | Normal | available inside |
| installation | | | | Abnormal | device |
| completed | | Not | Approved | Abnormal | Installation |
| | | Installation | Not Approved | Normal | clear |
| | | | | Abnormal | Certificate |
| | | | | | information (UI) |
| | | | | | and common |
| | | | | | certificate |
| 4: Remote device | Initialization | Installation | Approved | Normal | All functions not |
| management system | not completed | finished | | Abnormal | available |
| installation in | | | Not Approved | Normal | |
| progress | | | | Abnormal | |
| | | Not | Approved | Normal | |
| | | Installation | | Abnormal | |
| | | | Not Approved | Normal | |
| | | | | Abnormal | |

As illustrated in FIG. 5, the state is configured to include four kinds of minor states, an “initialization state”, an “installation state”, a “communication approval state”, and a “certificate state”, and states in four patterns are created with a combination of the four kinds of minor states. Each of kinds of functions which may be performed changes.

First, the number of functions that are able to be performed is increased as the state changes in the following sequence starting with No. 4: “4. remote device management system initialization in progress” (Step S501), “3. remote device management system initialization completed” (Step S502), “2. remote device management system available for normal use, and before installation” (Step S503), “1. remote device management system available for normal use” (Step S504).

In the first “No. 4”, there is no function that is able to be performed and in the next “No. 3”, the function may be served in which communication with the outside is not permitted. When the state changes to “No. 2”, only installation and registration may be performed. In No. 2 state, all of the states are basically normal, but the installation state is “non-installation”, and this indicates a state in which the device is not registered as a monitoring-needed device that the remote device management system monitors. Therefore, the state changes to the “installation completed” state by performing the reference and registration processing and all of the functions may be served by changing to “1. remote device management system available for normal use.” The reference and registration processing sequence is illustrated in FIG. 7.

Other initial states are basically determined during the initialization process (Step S501). When the initialization process is completed, the state changes to the “No. 3” (Step S502), but when the state that is obtained during the initialization process is “certificate state: normal” and moreover “communication approval state: approved”, the state changes to the “No. 2” state (Step S503), and in addition when the state is “installation state: installation completed”, the state changes to the “No. 1” state (Step S504). This initialization process sequence is illustrated in FIG. 6.

FIG. 6 is an explanatory diagram for describing the sequence in the configuration that is specifically described in FIG. 2.

FIG. 6 is one example of a sequence diagram of the initialization process for writing the state described in FIG. 5, at the time of starting.

When the state-in-device monitoring unit 103 notifies the start completion to the event reception unit 104 (Step S601), the event reception unit 104 sends processing distribution request (start completion notification) to the processing distribution unit 106 (Step S602). The processing distribution unit 106 generates an initialization processing unit 204 referring to Table 1 and makes a response to the event reception unit 104 (Steps S603 and S604).

When the event reception unit 104 performs the processing execution (the start completion notification) on the initialization processing unit 204 (Step S605), the initialization processing unit 204 performs certificate state check on the device state management unit 108 (Steps S606 and S607).

The initialization processing unit 204 sends a certificate state (normal) notification to the event reception unit 104 (Step S608), performs installation state check on the data management unit 107 (Steps S609 and S610), and performs installation state (installation completion) notification on the event reception unit (Step S611).

Furthermore, the initialization processing unit 204 performs communication setting check on the data management unit 107 (Step S612), performs communication approval state notification (approving notification) on the event reception unit 104 (Step S614), and performs initialization completion notification (Step S615).

The initialization processing unit 204 performs message generation (start completion notification) (Step S616) and transmits the message to the communication unit 109 (Step S617). The communication unit 109 transmits the message to the center system 110 (Step S618) and makes a response to the initialization processing unit 204 (Step S619).

The initialization processing unit 204 performs the processing completion notification on the event reception unit 104 (Step S620). The event reception unit 104 makes a response to the state-in-device monitoring unit 103 (Step S621).

That is, the processing by the remote device management system uses, for example, the communication function of the device. Because of this, the design is provided in such a manner that the initialization process is first performed at the time when the projector (the device) completes the starting (The processing is first performed after receiving the event of the start completion notification). By completing this processing, the initialization state switches to the initialization completion, and changes to the “3. remote device management system initialization completed” state. Then the change to the “2. remote device management system available for normal use and before installation” state or the “1. remote device management system available for normal use” is performed, based on the result of checking for the “certificate state”, the “installation state”, and the “communication state” that are performed during the initialization process.

Furthermore, time synchronization with the server side is completed, at the time when the communication with the center system is once completed over the network, by the start completion notification immediately after initialization, because a clock is not present in the projector.

FIG. 7 is an explanatory diagram for describing the sequence at the time of performing the installation process.

FIG. 7 is the sequence of the installation process, but the “installation process” in the remote device management system means that “reference execution” and “registration execution” (refer to the event minor items in Table 1) are performed at the request of the user operation control unit 102 and lead to the successful result, thereby changing to the “installation completion” state.

This installation process is performed by installation processing units 202a and 202b.

First, the “reference execution” request reaches the event reception unit 104 from the user operation control unit 102 (Step S701), and the event reception unit 104 hands the event of the reference execution over to the processing distribution unit 106 (Step S702).

The processing distribution unit 106 refers to the map in Table 1, generates the installation processing unit 202a (Step S703), and hands the installation processing unit 202a over to the event reception unit 104. The event reception unit 104 requests an installation processing unit 202 to perform the processing execution (Step S704). The flow of the reference execution ends here.

The installation processing unit 202a performs reference state check on the device state management unit 108 (Steps S705 and S706), the message is generated (the reference execution: Step S707), and the message is transmitted to the communication unit 109 (Step S708).

The communication unit 109 transmits the message to the center system 110 (Step S709) and makes a response to the installation processing unit 202a (Step S710).

The installation processing unit 202a sends the processing completion notification to the event reception unit 104 (Step S711).

The event reception unit 104 makes a response to the user operation control unit 102 (Step S712).

The “registration execution” request arrives from the user operation control unit 102 in a similar way after the processing is completed (Steps S712 and S713).

When the registration execution request arrives at the event reception unit 104 from the user operation control unit 102 (Step S713), the event reception unit 104 performs the processing distribution request (the reference execution) on the processing distribution unit 106 (Step S714). The processing distribution unit 106 generates the installation processing unit 202b (Step S715).

When the event reception unit 104 requests the installation processing unit 202b to perform the processing execution (the registration execution) (Step S716), the installation processing unit 202b performs registration state check on the device state management unit 108 (Step S717). The installation processing unit 202b obtains version information from the data management unit 107 (Steps S718 and S719) and generates the message (monitoring registration execution: Step S719). The installation processing unit 202b transmits the message to the communication unit 109 (Step S720). The communication unit 109 transmits the message to the center system 110 (Step S720). The communication unit 109 makes a response to the installation processing unit 202b (Step S722).

The installation processing unit 202b generates the message (customer number inquiry execution: Step S723) and transmits the message to the communication unit 109. The communication unit 109 makes a response to the installation processing unit 202b (Step S726).

The installation processing unit 202b obtains a model name from the data management unit 107 (Steps S727 and S728) and transmits the message to the communication unit 109 (Step S730). The communication unit 109 makes a response to the installation processing unit 202b (Step S732).

The installation processing unit 202b performs the processing completion notification on the event reception unit 104 (Step S733).

Also in this case, the flow remains the same, but is changed in that the number of times that the messages are exchanged with the center system is three.

So far, a reference is made to the sequence diagram at the time of the error occurrence illustrated in FIG. 2, the sequence diagram of the initialization process in FIG. 6, and the sequence diagram of the installation process in FIG. 7. The detailed sequences of the processing units are different from each other, but it is understood that the “flow of the processing until the description of the detail of the processing unit”, and the “other exchanging party to the processing unit (the “data management”, the “device state management”, and the “communication unit”)” are all made common.

This means that the processing may be made common and each of the processing units is divided into change units that write and transmit the message to be exchanged with the center system 110. Accordingly, the remote device management system, in which the memory saving, resulting from making the processing common, is possible may be realized and may easily correspond to future extension.

### Program

The information processing apparatus in accordance with the present embodiment described above may be realized by a program that causes the processing to be executed in a computer. For example, a general-purpose computer, such as a personal computer and a workstation, is enumerated as the computer, but the present invention is not limited to this kind of computer. Accordingly, the case where the present invention is realized by the program is described below as one example.

For example, the program is enumerated which causes the computer of the information processing apparatus, which is remotely managed by a management apparatus, to execute the following procedures: the user operation control unit generates the event by the user's operation; the state-in-device monitoring unit generates the event; the event reception unit receives the event generated inside; the processing distribution unit determines distribution to the event processing unit that corresponds to the event; the event processing unit generates the message, generated by the processing distribution unit, to be transmitted to the management apparatus; and the communication unit transmits the message to the management apparatus.

Thus, as long as there is an environment in which the program is executable on the computer, the information processing apparatus in accordance with the present invention may be realized in all places. The program like this may be stored in a computer-readable storage medium.

### Storage Medium

Here, for example, computer-readable media, such as a compact disc read only memory (CD-ROM), a flexible disk (FD), and a CD recordable (CD-R), semiconductor memories, such as a flash memory, a random access memory (RAM), a read only memory (ROM), and a ferroelectric memory (FeRAM), and a hard disc drive (HDD) are enumerated as the storage medium.

In accordance with the present embodiment, in the monitoring-needed device that the remote device management system monitors, the configuration that enables the memory saving resulting from making the reception unit common may be realized by retaining the made-common event reception unit, at the time of performing the processing on the basis of the event from the user operation control unit and the state-in-device monitoring unit.

In accordance with the present embodiment, in addition to the above-described configuration, adopted is the configuration that prepares the event processing unit, which is a part that performs the processing using the data management and the device state management, and the communication unit, as a common unit, and prepares an independent part, which corresponds to each processing, as an expansion, with the configuration that uses the data management and the device state management, and the communication unit. Because of this, the memory saving due to making common, and the expandability improvement by the division into the common and change units may be achieved.

In accordance with the present embodiment, in addition to the above-described configuration, the map of correspondence between each processing unit and the event is consolidated into the processing distribution unit by retaining data that is a result of performing mapping between the event occurring inside the device and the message (the processing content) that has to be exchanged with the center system, and arranging the processing distribution unit that generates each processing unit from the event. Because of this, the event reception unit is not supposed to recognize the detail of the event processing unit, and thus an influence range may be decreased at the time of further extension.

In accordance with the present embodiment, in addition to the above-described configuration, the manual call processing unit is prepared as an extension unit to the event processing unit and the manual event processing (mainly the user operation control unit), such as communication test call, polling manual execution, and service person job/end is performed. Because of this, the mounting of only a part specialized in writing each message may be enabled.

In accordance with the present embodiment, in addition to the above-described configuration, the device event processing unit is prepared as an extension unit to the event processing unit, and the processing on the event of a device state change such as an error notification is performed. Because of this, an association with the event from the state-in-device monitoring is mounted in the device event processing unit because there are many different associations with the events grasped from the state-in-device monitoring. Since there is a unit which is common between the event reception unit and the event processing unit, this processing unit can be achieved by only the mounting of the part specialized in writing each message.

In accordance with the present embodiment, in addition to the above-described configuration, the configuration in which all of the states are managed in the event processing unit is adopted. Accordingly, the processing performed in the processing unit is further limited to the writing and transmitting of the message. Because of this, the expandability is improved.

In accordance with the present embodiment, in addition to the above-described configuration, in the initialization processing unit, the “installing state”, the “communication approval state”, and the “certificate state” are checked for and the state at the starting time is established by performing the notification on the event reception unit. Because of this, the notification concerning the state change can be performed with the same configuration as the basic event processing unit. Accordingly, the state change may be realized without preparing excessive processing.

In accordance with the present embodiment, in addition to the above-described configuration, the notification concerning the state change can be performed with the same configuration as the basic event processing unit. Because of this, the state change may be realized without preparing excessive processing.

That is, the mapping is performed between the message that the device, as the system, exchanges with the center side, and the event that occurs inside the device, and additionally the common part of each processing unit is configured as the common unit by the event processing unit serving as an interface. In this way, the device that corresponds to the remote management system may be realized with the memory saving and the preparation may be provided also for an extension using a future device.

In short, the information processing apparatus in accordance with the present embodiment is managed with the mapping between the event occurring inside the device and the message (the processing content) that has to be exchanged with the center system.

### Second Embodiment

As described in the first embodiment, basically, the event processing unit once receives all of the events that occur in the device. Next, the event is handed over to the processing distribution unit and the event processing unit that has to process that event is returned. From a perspective of the event reception unit, the detail of the event processing unit is not known and is simply caught as the “event processing unit”, and the processing is completed only by handing over the event that occurs. To sum up, the configuration is such that the processing distribution unit knows all of the kind of the event that occurs, and the kind of the event processing unit that has to process that event.

In a second embodiment, a configuration example is illustrated in which the mapping between the event that occurs and the event processing unit is updated.

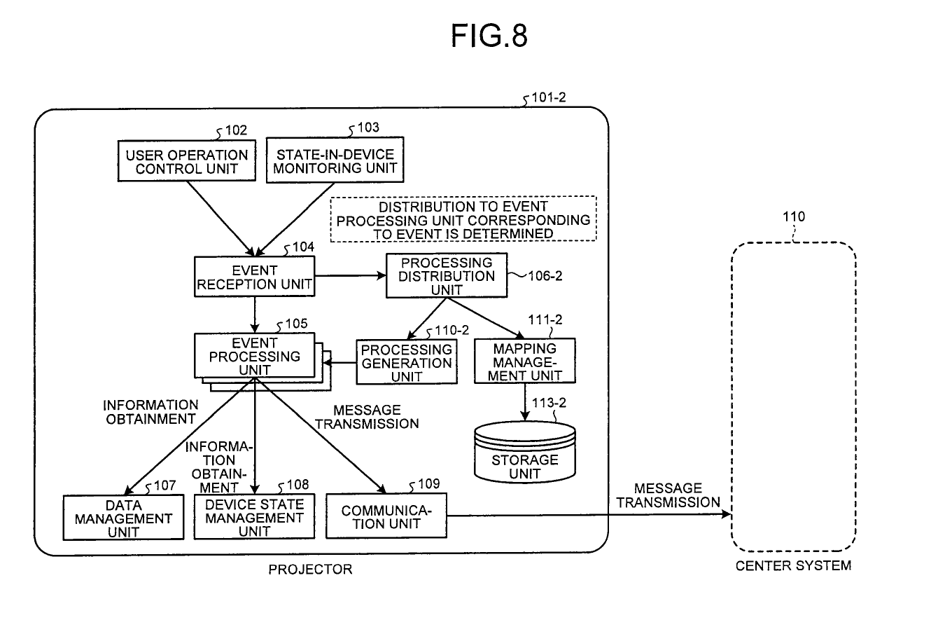

FIG. 8 is an explanatory diagram for describing a software configuration of a remote management system, as a whole, using an information processing apparatus in accordance with the second embodiment. The system, illustrated in FIG. 8, includes an information processing apparatus 101-2, and the center system 110 as a management apparatus that remotely manages the information processing apparatus 101-2.

The information processing apparatus 101-2 includes the user operation control unit 102, the state-in-device monitoring unit 103, the event reception unit 104, the event processing unit 105, a processing distribution unit 106-2, the data management unit 107, and the device state management unit 108, and the communication unit 109, a processing generation unit 110-2, a mapping management unit 111-2, and a storage unit 113-2.

What distinguish the second embodiment from the first embodiment are the function of the processing distribution unit 106-2 and the addition of the processing generation unit 110-2, the mapping management unit 111-2, and the storage unit 113-2. Since other configurations and functions are the same as those in FIG. 1, which is a block diagram in accordance with the first embodiment, same reference numerals are given and the descriptions are omitted here.

The processing generation unit 110-2 is in association with the mapping management unit 111-2 and the processing generation unit. The mapping management unit 111-2 takes over the event, which occurs, from the processing distribution unit 106-2, and refers to a table for mapping between the event and the processing unit to be generated, which is stored in the storage unit 113-2. The mapping management unit 111-2 returns the name of the event processing unit that corresponds to the event and that has to be generated, referring to the table (the map) for mapping.

The table for mapping (Table 1 and others) may be made updated by adopting the configuration in which the mapping management unit 111-2 reads the table for mapping at the time of the event occurrence. For example, when the map stored beforehand in the storage unit 113-2, by the user, is updated, the processing is done to be performed using the post-update map, for example, at the time of the event occurrence. The timing of this reading may be changed in accordance with the kind of device and others. For example, in a device, like MFP, which is always powered on, the configuration may be such that the reading is performed each time the event occurs, and in a device, like the projector, which is frequently powered on and off, the configuration may be such that the reading is performed each time the device is powered on.

In addition, in FIG. 8, the storage unit 113-2 is provided inside the information processing apparatus 101-2, but the storage unit 113-2 may be configured to be provided inside an external storage apparatus that is in connection, for example, over a network.

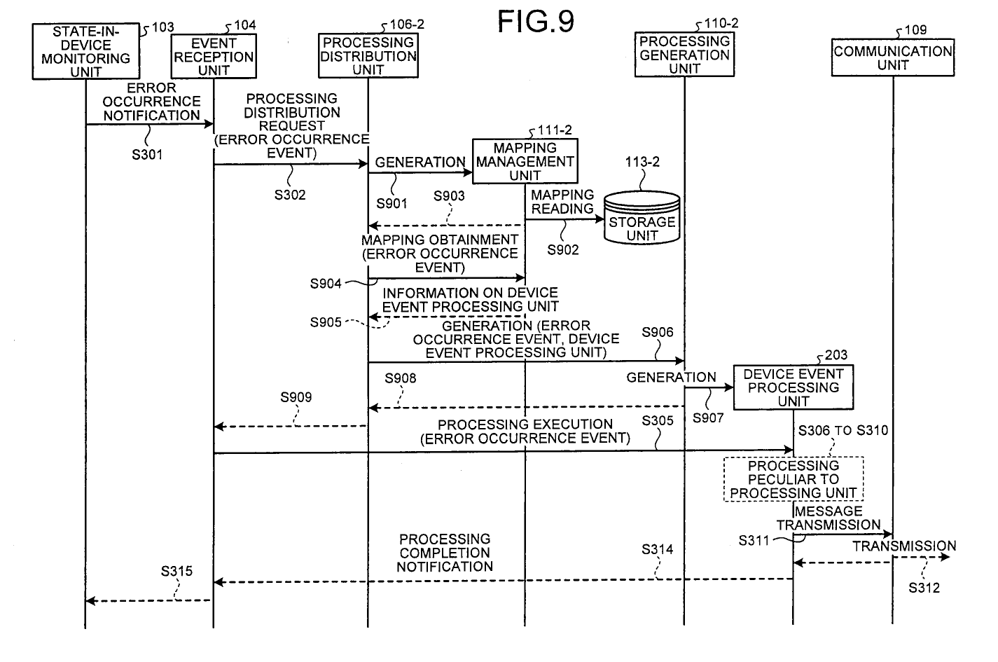

FIG. 9 is a diagram for describing the sequence at the time of the error occurrence in the second embodiment. FIG. 9 illustrates the sequence diagram in a case where an error occurrence notification is issued inside the device. In addition, same reference numerals are given to the same processing as that in FIG. 3, and the description of the same processing is properly omitted.

The event reception unit 104 that receives the error occurrence notification from the state-in-device monitoring unit 103 performs requesting the processing distribution unit 106-2 to perform the processing distribution (Step S302). At this time, the event of the error occurrence notification is handed over.

The processing distribution unit 106-2 hands the event over to the mapping management unit 111-2 (Step S901). The mapping management unit 111-2 reads the map of correspondence between the event and the processing unit from the storage unit 113-2 (Step S902), and notifies the reading completion (Step S903).

The processing distribution unit 106-2 requests the mapping management unit 111-2 to permit the obtainment of the map of correspondence that corresponds to the error occurrence event (Step S904). The mapping management unit 111-2 hands over the device event processing unit, which is a processing unit corresponding to the error occurrence event, to the processing distribution unit 106-2 (Step S905).

The processing distribution unit 106-2 hands over information on the event that occurs and the event processing unit (here, the device event processing unit) that has to process that event, to the processing generation unit 110-2 (Step S906). At this time, the processing distribution unit 106-2 does not need to grasp the detail of the processing unit, because only the information and the event that are returned from the mapping management unit flow.

Next, the processing generation unit 110-2 generates the device event processing unit (Step S907), and hands the device event processing unit over to the event reception unit 104 via the processing distribution unit 106-2 (Steps S908 and S909). The event reception unit 104 requests the event processing unit, which is returned from the processing distribution unit 106-2, to perform the processing execution (Step S305). Also at this time, the event reception unit 104 hands over the event (the error occurrence notification). The device event processing unit (the event reception unit 104 recognizes the device event processing unit as the “event processing unit”) on which the processing execution is performed builds up the message and transmits the message to outside the device, via a transmittance unit (Steps S306 to S312). The message here is the “error occurrence message”. Here, even though the first event trigger is the event from the user operation control unit 102, the basic flow is not changed.

According to the embodiments, the provision of the information processing apparatus, the information processing method, and the program that are capable of enabling embedded functions with memory saving and of accommodating future expandability and evolution may be realized.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus remotely managed by a management apparatus, the information processing apparatus comprising:
an event reception unit configured to receive an event that occurs inside;
a plurality of event processing units configured to generate a message to be transmitted to the management apparatus, the event processing units corresponding to events, respectively; and
a processing distribution unit configured to determine distribution of the event received by the event reception unit to the corresponding event processing unit, wherein
the event processing units are generated by the processing distribution unit.

2. The information processing apparatus according to claim 1, further comprising:
a user operation control unit configured to generate the event by a user's operation; and
a state-in-device monitoring unit configured to monitor the event that occurs inside the information processing apparatus.

3. The information processing apparatus according to claim 1, wherein each of the event processing units obtains error communication information, obtains a communication state, and generates a message, during an initialization process.

4. The information processing apparatus according to claim 1, wherein each of the event processing units checks a certificate state, checks an installation state, changes communication setting, and generates a message, during an initialization process.

5. The information processing apparatus according to claim 1, wherein each of the event processing units checks a reference state and generates a message during an initialization process at a time of reference execution, and obtains version information or a model name, and generates a message during the initialization process at a time of registration execution.

6. The information processing apparatus according to claim 1, wherein
the processing distribution unit itemizes the events for classification and includes a map of processing in accordance with the classification, and
the event processing units include
a manual call processing unit including communication test call, service man job start, service man job end, and polling manual execution,
an installation processing unit including reference execution and registration execution,
a device event processing unit including periodic information notification and error occurrence notification, and
an initialization processing unit including start notification.

7. The information processing apparatus claim 1, further comprising a mapping management unit configured to read correspondence information in which each event is mapped to the corresponding event processing unit, from a storage unit that stores the correspondence information,
wherein the processing distribution unit determines the distribution of the event to the corresponding event processing unit with reference to the read correspondence information.

8. The information processing apparatus according to claim 7, wherein the mapping management unit reads the correspondence information in predetermined timing.

9. The information processing apparatus according to claim 7, wherein the storage unit is a storage unit of an external storage apparatus.

10. The information processing apparatus according to claim 1, further comprising a processing generation unit configured to generate the event processing unit corresponding to the event in response to a request of the processing distribution unit.

11. An information processing method comprising:
collecting information and state from an inside of an information processing apparatus in response to an event with regard to the information processing apparatus as a trigger;
generating a message that is mapped to the event and is to be actually exchanged, from the collected information; and
transmitting the message from the information processing apparatus to a management apparatus that remotely manages the information processing apparatus.

12. A non-transitory computer-readable storage medium with an executable program stored thereon, wherein the program instructs a computer of an information processing apparatus remotely managed by a management apparatus, to perform:
generating an event by an user's operation through a user operation control unit;
generating an event by a state-in-device monitoring unit;
receiving an event that occurs inside by an event reception unit;
determining, by a processing distribution unit, distribution of the event to an event processing unit that corresponds to the event;
generating, by an event processing unit, a message the event processing unit generates a message to be transmitted to the management apparatus; and
transmitting the message to the management apparatus by a communication unit.
